(19) United States
(12) Patent Application Publication
(10) Pub. No.: US 2014/0181753 A1
(43) Pub. Date: Jun. 26, 2014

(54) ELECTRONIC DEVICE

(71) Applicants: Toshihiro Kamii, Osaka-shi (JP); Keiji Takaku, Kobe-shi (JP)

(72) Inventors: Toshihiro Kamii, Osaka-shi (JP); Keiji Takaku, Kobe-shi (JP)

(73) Assignee: KYOCERA CORPORATION, Kyoto-shi, Kyoto (JP)

(21) Appl. No.: 14/114,014

(22) PCT Filed: Apr. 25, 2012
(86) PCT No.: PCT/JP2012/061098

§ 371 Date: Dec. 30, 2013

(30) Foreign Application Priority Data
Apr. 26, 2011 (JP) 2011-098046
Apr. 26, 2011 (JP) 2011-098047

(51) Int. Cl. G06F 3/0484; G06F 3/0488

(52) U.S. Cl. CPC G06F 3/04842; G06F 3/0488
USPC 715/840

(57) ABSTRACT

An electronic device of the present invention includes display modules having display screens, respectively, touch panels that are provided on the display screens and accept touch input, and a selecting module for selecting two or more contents about which touch input is accepted by the touch panels when a plurality of contents are displayed on the display modules. When the selected contents are reselected, the selecting module cancels the selection. Further, a program of an electronic device according to the present invention executes a process for selecting two or more contents about which the touch input is accepted by the touch panels when the plurality of contents are displayed on the display modules, and a process for canceling the selection when the selected contents are reselected.

### TECHNICAL FIELD

The present invention relates to an electronic device having a display screen and a touch panel. More specifically, the invention relates to the electronic device in which operability at a time when a plurality of contents are selected can be improved.

### BACKGROUND ART

Electronic devices, which have a display screen being capable of displaying various information and a touch-panel type operating unit provided on the display screen, are known.

Touch panels, which employ a finger pressure sensor system, a resistive-type system and a capacitive-type system, are known. Users visually recognize characters and images displayed on the display screen, and also can execute processing such as operating and editing data and folders (hereinafter, “contents”) according to mounted applications through tapping, double tapping, flicking, dragging or the like of the touch panels.

For example, when the application is mail software and a mail is created, contents such as image data and document data can be attached to the mail through an operation on the touch panel.

Further, in a case of music players, music data and music files can be selected by an operation on the touch panel, so as to be listened to.

When contents such as image data are attached to mails or are selected for the other operations, users should specify the contents one by one, and thus have to repeat the above operation in order to select the plurality of contents. Therefore, the operation requires time and effort, and the operability is not sufficient.

Further, so-called check boxes for enabling selection of predefined choices enable the selection of the plurality of contents. However, also in this case, radio buttons corresponding to the contents desired to be selected should be specified one by one by tapping or the like, and thus the operation requires time and effort.

Therefore, electronic devices that improve the operability at a time of sequentially selecting the plurality of contents are desired.

### SUMMARY OF THE INVENTION

An electronic device according to one aspect of the present invention includes:

a display module having a display screen;

a touch panel that is provided on the display screen and accepts touch input; and

a selecting module configured to select two or more contents about which the touch input is accepted by the touch panel when a plurality of contents are displayed on the display module, wherein

when the selected contents are reselected, the selecting module cancels the selection.

A program of an electronic device according to one aspect of the present invention allows a computer of the electronic device provided with a display module having a display screen, and a touch panel, provided on the display screen, for accepting touch input, to execute

a process for selecting two or more contents about which touch input is accepted by the touch panel when the plurality of contents are displayed on the display module, and

a process for canceling the selection when the selected contents are reselected.

An electronic device control method according to one aspect of the present invention is a method for controlling the electronic device including

a display module having a display screen, and

a touch panel, provided on the display screen, for accepting touch input, the method comprising:

selecting two or more contents about which the touch panel accepts the touch input when a plurality of contents are displayed on the display module; and

canceling the selection when the selected contents are reselected.

### BRIEF DESCRIPTION OF THE DRAWINGS

FIG. 1 is a perspective view of an electronic device according to one embodiment of the present invention.

FIG. 2 is a block diagram of the electronic device according to one embodiment of the present invention.

FIG. 3 is an explanatory diagram illustrating a file manager screen according to one embodiment of the present invention.

FIG. 4 is a flowchart diagram illustrating an operation according to one embodiment of the present invention.

FIG. 5 an explanatory diagram illustrating a process for disabling overlapping contents according to one embodiment of the present invention.

FIG. 6 is an explanatory diagram illustrating a display screen indicating a state that selected contents are attached to a mail according to one embodiment of the present invention.

FIG. 7 is an explanatory diagram illustrating a playlist creating screen of a music file according to one embodiment of the present invention.

FIG. 8 is a flowchart diagram illustrating attachment of contents to a mail and transmission of the mail according to one embodiment of the present invention.

FIG. 9 is an explanatory diagram illustrating the display screen related to the flowchart diagram in FIG. 8.

FIG. 10 is an explanatory diagram illustrating a bookmark list creating screen on a moving image replay screen according to one embodiment of the present invention.

FIG. 11 is an explanatory diagram illustrating the file manager screen according to another embodiment of the present invention.

FIG. 12 is a flowchart diagram illustrating an operation according to another embodiment of the present invention.

FIG. 13 is an explanatory diagram illustrating the playlist creating screen of a music file according to another embodiment of the present invention.

### DETAILED DESCRIPTION OF EMBODIMENTS

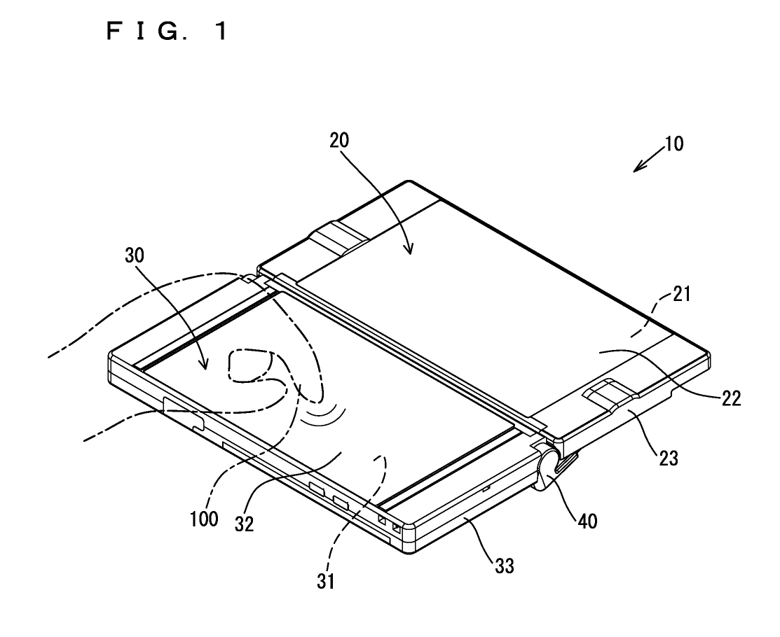

As shown in FIG. 1, an embodiment in which the present invention is applied to a portable-type electronic device 10 having two display screens 21 and 31 and touch panels 22 and 32 provided on the display screens 21 and 31 is described below. The electronic device 10 shown in the drawing is for description, and shall not limit the concrete structure and constitution thereof in understanding of the present invention.

The electronic device 10 according to the embodiment activates one or more applications on an operating system to be a platform, and displays various information on the display screens 21 and 31. Further, a user can operate the touch panel 22 and/or the touch panel 32 to execute processing such as operating and editing.

First, a structure of the portable electronic device 10 according to the embodiment is described.

The electronic device 10 is provided with, as shown in FIG. 1, display modules 20 and 30 having the display screens 21 and 31 and the touch panels 22 and 32, respectively. The display screens 21 and 31 can display information such as characters, graphics, images, videos, music and moving images related to applications desired by the user. Further, the touch panels 22 and 32 are disposed on the display screens 21 and 31, respectively, and can be operated by user's touching.

The display modules 20 and 30 can be constituted by coupling them by means of a coupling mechanism 40 so as to be movable relatively by opening/closing or sliding.

The number of the display modules 20 and 30 is not limited to two.

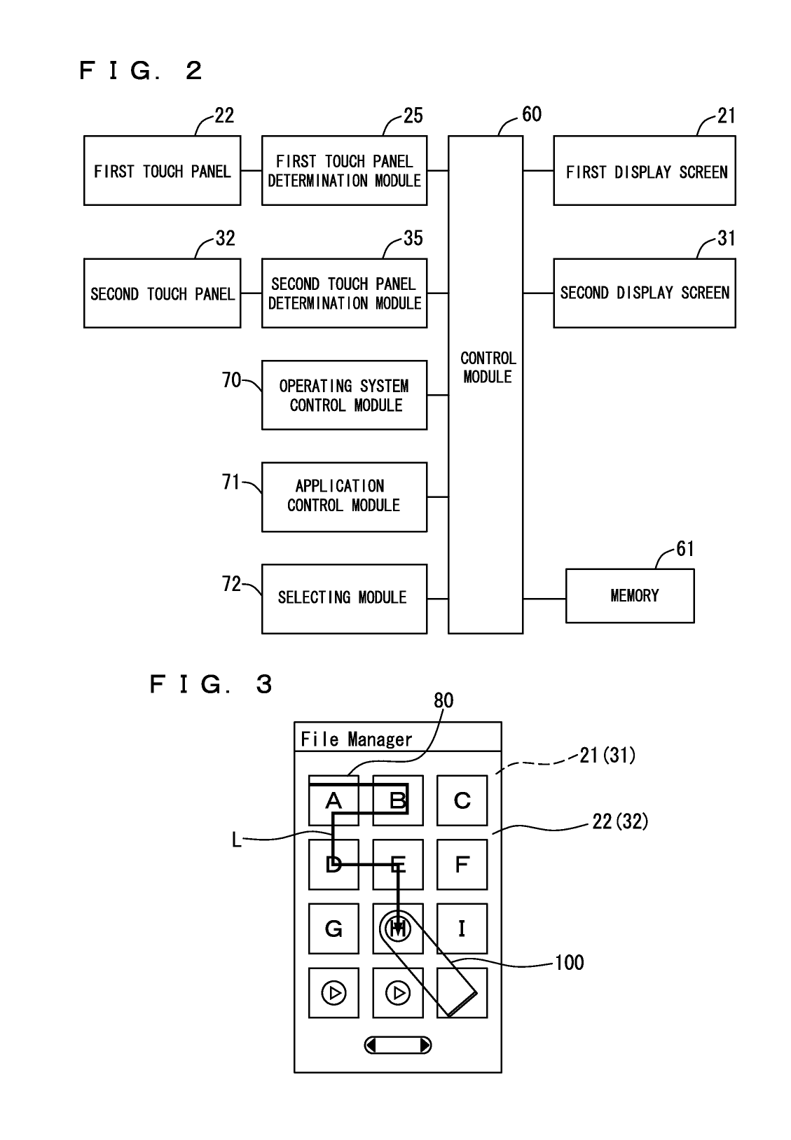

The first display module 20 and the second display module 30 are housed within casings 23 and 33 which are opened at their respective surfaces in one side, such that the display screens 21 and 31 capable of displaying information thereon can be viewed from the opened sides, as illustrated in FIG. 1. The display screens 21 and 31 are electrically connected to a control module 60 (see FIG. 2), which will be described later, and can display various types of information thereon. Further, referring to FIG. 1, the display module positioned in the right back side in the paper plane is referred to as the first display module 20, while the display module positioned in the left front side is referred to as the second display module 30.

The display screens 21 and 31 can illustrate a liquid crystal display. The touch panels 22 and 32 that the user can manipulate by touching them with a finger tip 100 or the like are provided to the respective opening sides of the display screens 21 and 31 as shown in FIG. 1. The touch panels 22 and 32 are disposed so as to block the openings of the casings 23 and 33, and are made transparent so that the display screens 21 and 31 can be visually recognized. The touch panels 22 and 32 that employ a finger pressure sensor system, a capacitive-type system, and a resistive-type system can be illustrated as an example.

The first display module 20 and the second display module 30 can be made to be movable with respect to each other through the coupling mechanism 40. Although the structure of the coupling mechanism 40 is not described in detail, this structure can be such that the first display module 20 is made to be slidable and/or rotatable with respect to the second display module 30, for example.

FIG. 2 illustrates one example of a block diagram of the electronic device of the present invention.

The electric device 10 is overall controlled by the control module 60 constituted by a CPU or the like, as illustrated in FIG. 2. As detailed below, the touch panels 22 and 32 are connected to the control module 60 via touch-panel determination modules 25 and 35. Further, the display screens 21 and 31, an operating system control module 70, an application control module 71, a selecting module 72, and a memory 61 to be a storage module are connected to the control module 60.

The first touch panel 22 and the second touch panel 32 are electrically connected to the control module 60 through the first touch-panel determination module 25 and the second touch-panel determination module 35. Inputs from the user through the first touch panel 22 and the second touch panel 32 are transmitted as coordinate information to the control module 60 via the touch panel determination modules 25 and 35, and the control module 60 edits the information on the display screens 21 and 31 and performs the operation in accordance with the input.

The touch panels 22 and 32 accept operations through a user's finger 100, a stylus pen or the like. Examples of the operations accepted by the touch panels 22 and 32 are tapping to be performed by touching the touch panels 22 and 32 for a comparatively short time and then releasing the finger from the touch panels 22 and 32, double tapping to be performed by tapping two times within a predetermined time, so-called dragging to be performed by moving a content selected on the touch panels 22 and 32 with it being touched, and so-called flicking to be performed by touching the touch panels 22 and 32 and then quickly brushing off. Another examples of the operations are so-called pinching to be performed by touching the touch panels 22 and 32 with two fingers and changing a distance between the fingers, so-called long touching to be performed by long-pressing one position of the touch panels 22 and 32, and so-called sliding (swiping) to be performed by touching the touch panels 22 and 32 and tracing the touch panels 22 and 32.

The first display screen 21 and the second display screen 31 are electrically connected to the control module 60, and can display various kinds of information related to operating system and application software to be used.

The operating system incorporated in the electronic device 10 is operated by an operating system control module 70 which is electrically connected to the control module 60. The operating system is a system that serves as an interface for applications and is adapted to perform activation and completion of applications, adjustment of the sound volume, displaying of the time of day, alarm setting, and other system operations.

Further, such various types of applications which are activated by the electronic device 10 are operated by an application control module 71 which is electrically connected to the control module 60, through the operating system. As such applications, mail software, a music player, a browser, and viewer software can be exemplified.

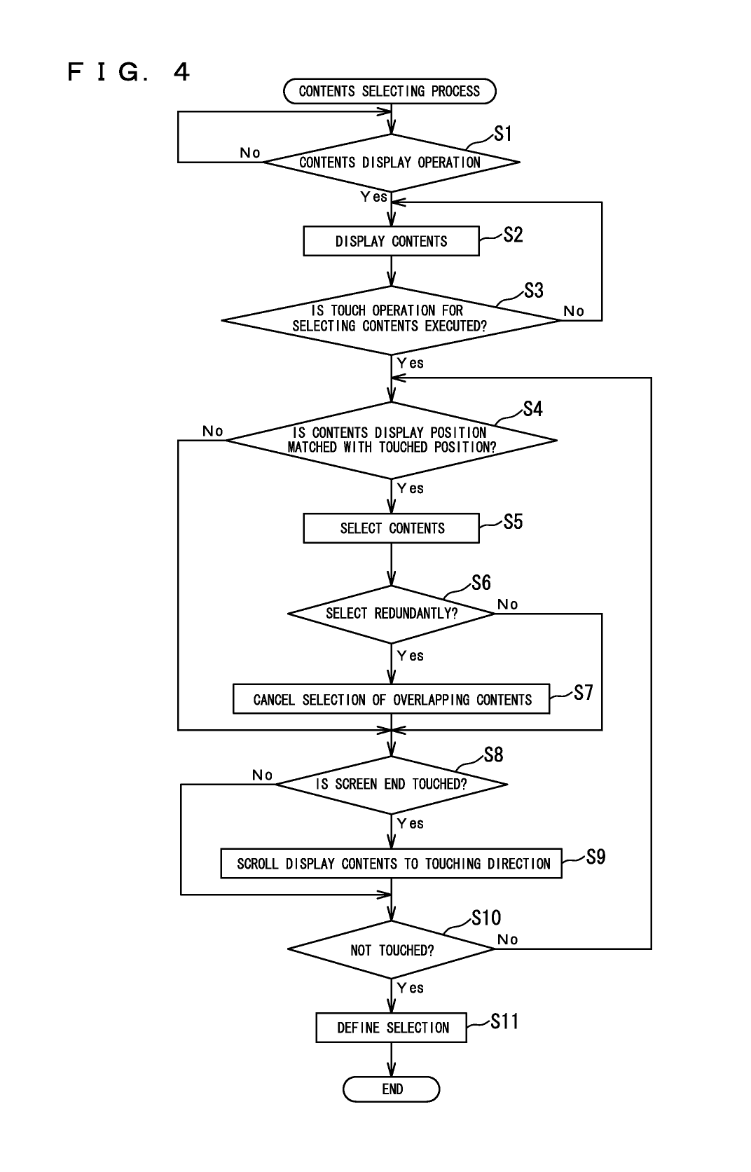

The electronic device 10 can operate the control module 60 or the like and activate an operating system and application to display contents (see step 1 in a flowchart of FIG. 4). FIG. 3 illustrates a list of a plurality of contents displayed on the first display screen 21 and/or the second display screen 31 (step 2). The screen in the drawing is a file manager screen for file management, and shows a thumbnail 80 as image data on the screen.

The electronic device 10 can display an image, an icon, a file name or a folder as contents instead of a thumbnail, or each folder name where contents are stored.

Concrete examples of contents are a list of data such as image data that can be attached to a created mail when mail software is activated, a list of music data in a case of a music player, a list of links (bookmark) in a case of a browser, and a list of image data and moving image data in a case of viewer software.

Contents can be stored in the memory 61 that is a storage module electrically connected to the control module 60. The memory 61 stores these contents and also the operating system, the applications and programs for performing various operations of the electronic device 10 and the following operations therein.

The selecting module 72 selects two or more contents through the user's operation on the touch panels 22 and 32 with the contents being displayed on the display screens 21 and 31 (see FIG. 3). The selecting module 72 is connected to the control module 60.

When the user touches the touch panels 22 and 32 with the finger 100 or the like with the contents being displayed on the display screens 21 and 31 (step 3) and the contents display positions of the display screens 21 and 31 correspond with touched positions (step 4), the selecting module 72 selects and extracts the contents sequentially, and creates a list of the extracted two or more contents.

More concretely, when signals are input into the touch panel determination modules 25 and 35 by a user's operation on the touch panels 22 and 32 (step 3), the selecting module 72 executes a contents selecting process described later (steps 5 to 7).

The contents selecting process is a process for sequentially selecting, as shown in FIG. 3, contents desired by the user on a touched route at a time when the user touches the touch panels 22 and 32 with respect to the contents displayed on the display screens 21 and 31 (step 3) and slides (swipes) the finger 100 or the like on the touch panels 22 and 32.

A flow of the selecting process to be executed by the electronic device 10 is described below more concretely. When contents are present on the route through the sliding operation, the selecting module 72 selects the corresponding contents (step 5).

For example, as indicated by a solid line L in FIG. 3, when the user traces the thumbnails 80 A, B, A, D, E and H (A is selected redundantly) with the finger 100 or the like in that order, the thumbnails 80 A, B, D, E and H are selected, respectively. At this time, it is desirable that the electronic device 10 blinks the selected thumbnail 80 based on the operation so that the user easily recognizes that the contents are selected, or an outer frame is displayed on an outer periphery of the thumbnail 80.

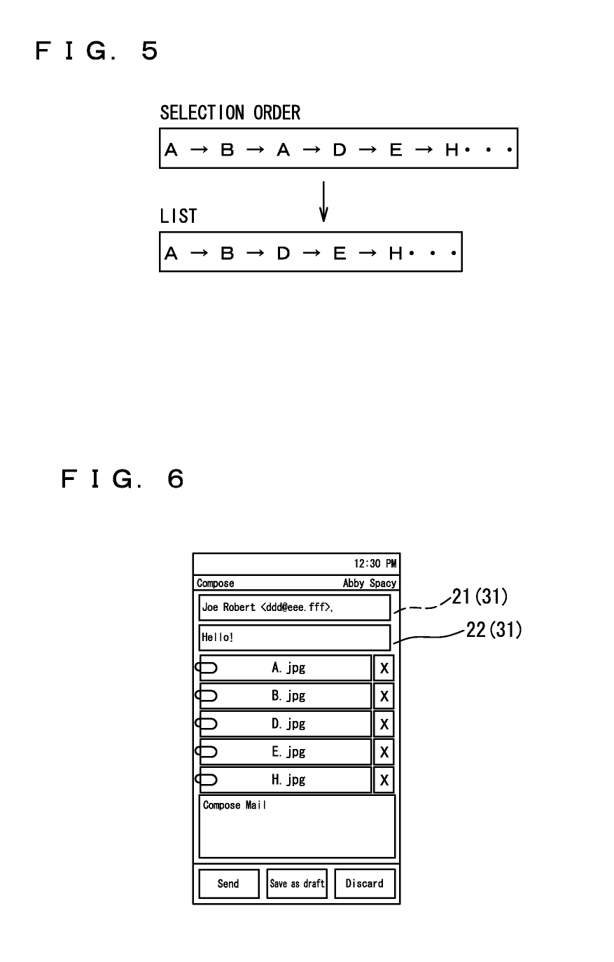

When the user performs the sliding operation on the touch panels 22 and 32 and traces the same content twice, the same content is selected redundantly more than once (see selecting order of FIG. 5). Concretely, the contents selected redundantly as indicated by the solid line L of FIG. 3 (in the drawing, a thumbnail A) may be stored directly in a list, described later, more than once. As shown at steps 6 and 7 in flowchart of FIG. 4, as to the contents that are selected more than once, however, the overlapping content selected later is deactivated as shown in the list of FIG. 5 in order to avoid the overlapping.

In a case where the thumbnails 80 and the icons of the contents are arranged on a plurality of screens, it is desirable that when the finger 100 or the like is slid to the ends of the display screens 21 and 31 with the touch panels 22 and 32 being touched or the ends of the display screens 21 and 31 are touched for a predetermined time (step 8), the sliding (swiping) operation is continued on the next screen on which the sliding is not currently performed (step 9).

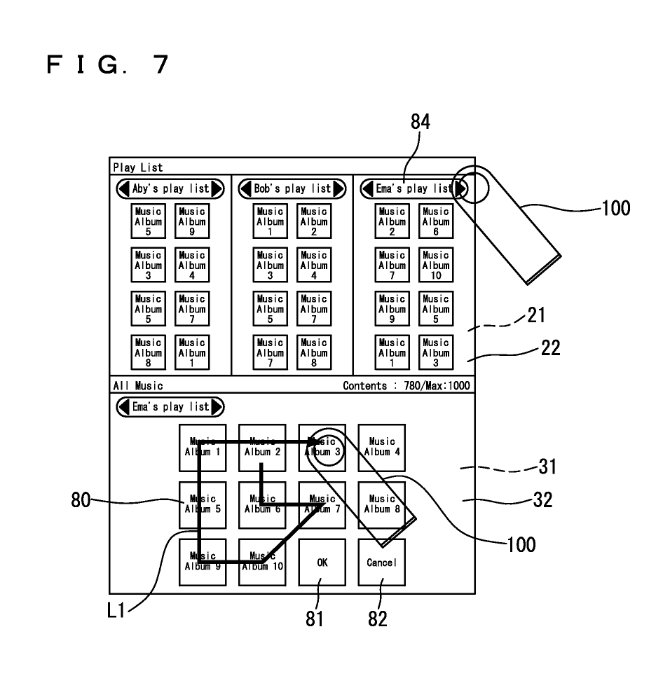

The selecting module 72 sequentially selects the contents until the user completes the sliding operation. The sliding operation is regarded as being completed, for example, when the user releases the finger 100 or the like from the touch panels 22 and 32 (step 10), and the contents selected in the contents selecting process can be defined (step 11). In the above mode, the selecting module 72 creates a list of the selected contents. The list created by the selecting module 72 is stored in the memory 61. The user can use the list created by the selecting module 72 for attachment to a mail (see FIG. 6) and creation of library of playlists (see FIG. 7).

When the user restarts the sliding operation within a predetermined time (for example, 3 seconds) after the sliding operation is completed, the electronic device 10 may continue the contents selecting process with return to step 3 in the flowchart of FIG. 4.

Further, when any contents selected by the user are reselected within a predetermined time after the sliding operation is completed, the electronic device 10 may execute a process for deleting the reselected contents from the list.

As shown in FIG. 7, thumbnails such as “OK” 81 and “Cancel” 82 are displayed on the screen, and when the thumbnail “OK” 81 is selected, the electronic device 10 may create a list. When the thumbnail “Cancel” 82 is selected, the electronic device 10 may cancel the creation of the list.

As a result, since the user can select two or more contents through an intuitive operation while visually recognizing the thumbnails 80 of the contents, the operability is improved as much as possible.

FIG. 6 illustrates a state that the created list shown in FIG. 3 to FIG. 5 is attached to a mail in mail software. In the drawings, the contents (in the drawing, .jpg images) are attached in order in the created list. When the order of contents is not important like the attachment to a mail, the contents may be attached in date order, in file name order of the contents and the like.

FIG. 7 illustrates a state that the electronic device 10 having the two display screens 21 and 31 shown in FIG. 1 is used and a music player is activated as an application. In the drawing, a plurality of playlists (libraries) are displayed on the first display screen 21 on the upper side, and a playlist creating screen is displayed on the second display screen 31 on the lower side. When the user selects a playlist created on the first display screen 21 (in the drawing “Ema's play list” (84), and a state after the creation of the list is shown for easy understanding of the description) through the operation on the touch panel 22, the electronic device 10 displays music files (in the drawing, “Music Albums 1 to 10”) stored in the memory 61 on the second display screen 31 in a format of the thumbnails 80.

In this state, as shown in the flowchart of FIG. 4 and by a solid line L1 in FIG. 7, the electronic device 10 selects music files in order of albums 2, 6, 7, 10, 9, 5, 1, 2, and 3 traced by the finger 100 according to the order of the albums desired to be replayed by the user. Since the album 2 is selected redundantly, the selection of the overlapping file selected later is deactivated in a manner described at steps 3 and 4 in the flowchart of FIG. 4 and in FIG. 5. When the user completes the sliding operation and a predetermined time passes or the user taps “OK” 81, the electronic device 10 creates a list, and registers albums in “Ema's play list” (84) in the selected order.

Therefore, the user can replay the registered playlists to listen to desired music files in the desired order.

In a case of a music file or the like, since the play order according to user's fondness is important, it is suitable to create a list in the selected order.

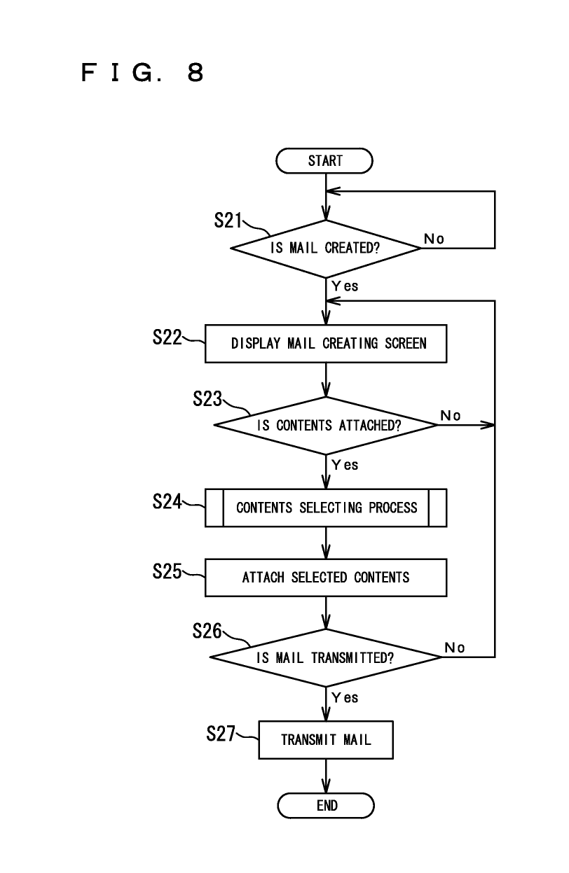

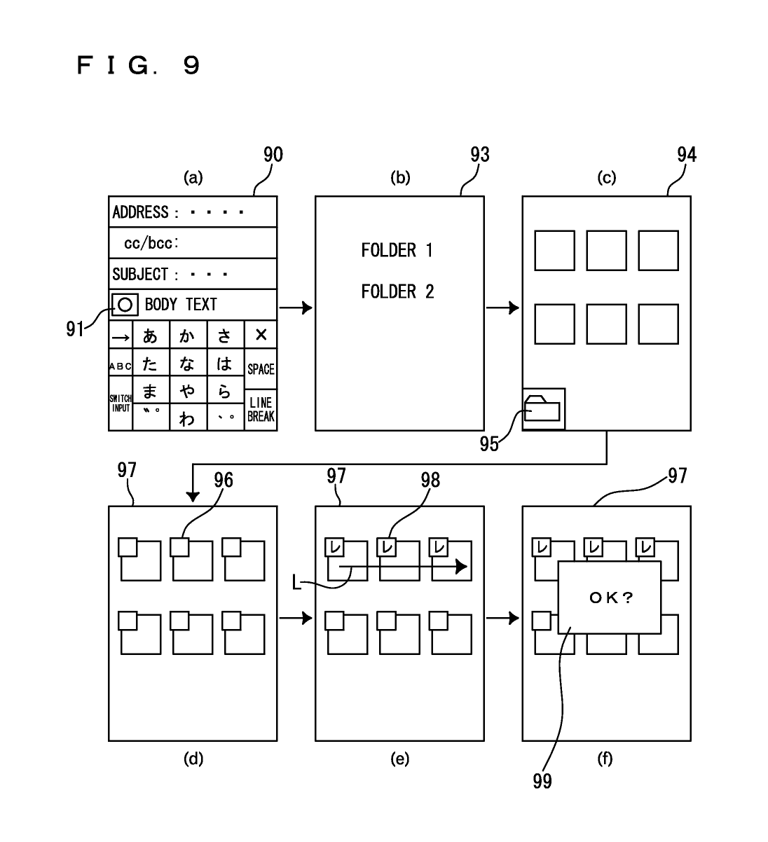

FIG. 8 and FIG. 9 illustrate a flow of the creation and transmission of mails to which contents are attached and concrete examples of screen display.

When the mail creating operation is input by the user as shown at step 21 in FIG. 8 in a state that the mail software is activated, a mail creating screen 90 is displayed on at least one of the display screens 21 and 31 as shown at step 22 in FIG. 8 and in FIG. 9(a). At this time, as indicated by a symbol 91 in FIG. 9(a), if a contents attachment button is operated (step 23), a contents selecting screen 93 is displayed as shown in FIG. 9(b), and the contents selecting process described in FIG. 4 is executed (step 24). More concretely, as shown in FIG. 9(b), the electronic device 10 displays the selecting screen 93 for specifying storage places of the contents to be attached, and when, for example, the user selects a desired folder, it displays a list screen 94 of the contents included in the selected folder as shown in FIG. 9(c).

Since the operation of tracing the touch panel is recognized as another operation such as dragging in some applications, a button 95 for acknowledging that the sequence goes to the process for selecting contents is provided in the present invention.

When the user operates the acknowledge button 95, the electronic device 10 moves to display of a file list screen 97 with check boxes 96 as shown in FIG. 9(d). The electronic device 10 accepts an operation of selecting a desired file from the user in the manner in the flowchart of FIG. 4. As a result, as shown in FIG. 9(e), a check mark 98 is placed on a check box of a selected file and when the user releases the finger from the touch panel, the selected content is attached (step 25).

Before the content is confirmed, it maybe checked whether the content selected by a pop-up 99 may be attached.

After the content is attached to a mail, when the user selects mail transmission on the mail creating screen (step 26), the mail to which the content is attached is transmitted (step 27).

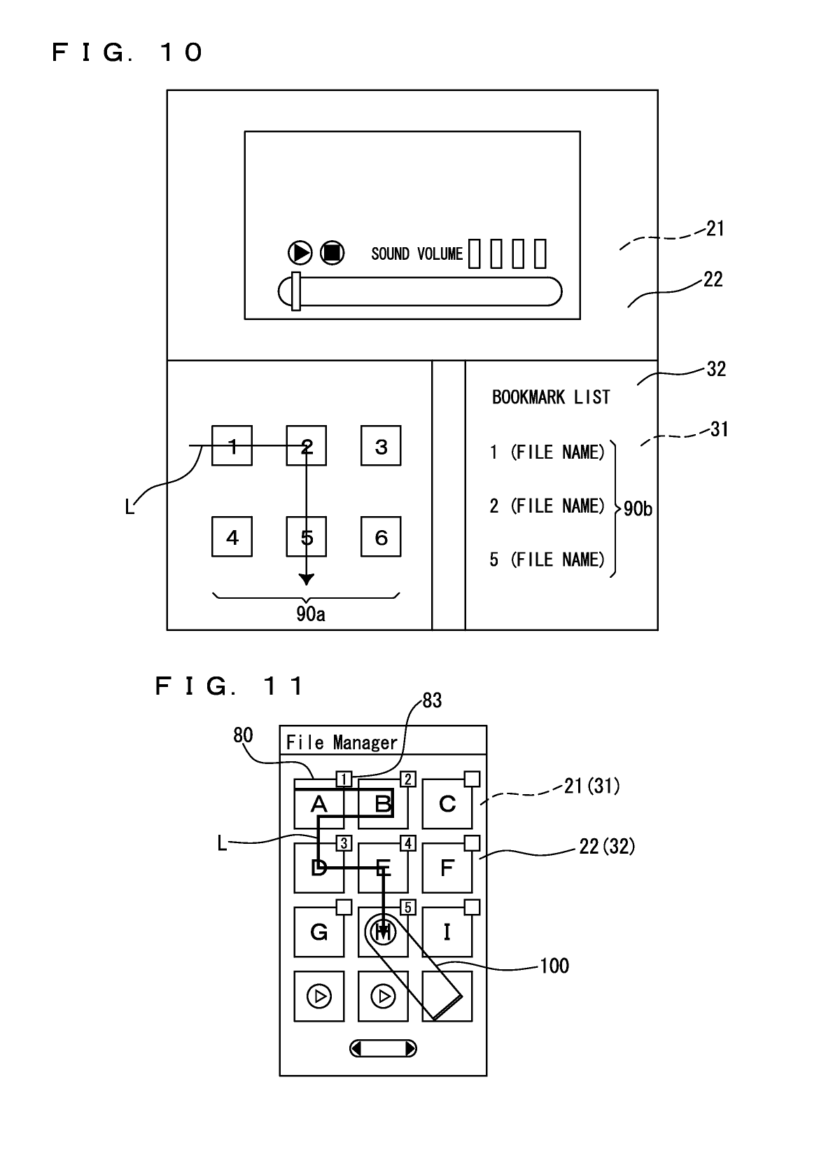

FIG. 10 illustrates an embodiment where the present invention is applied to moving-image replay software.

In the embodiment shown in the drawing, the upper display screen 21 displays a moving-image replay screen, and the lower display screen 31 displays a list 90a of moving images searched in the Internet or the like and a filename 90b of a created bookmark list.

When a moving image is selected in the manner in the flowchart of FIG. 4 (in the drawing, moving images 1, 2 and 5 are sequentially selected), a list of the selected moving images are added to the bookmark list according to the selected order. At this time, the contents in the bookmark list are buffered so that the moving images can be smoothly replayed.

According to the present invention, the user can select two or more contents only by tracing desired contents, and can create a list according to the order. Since this operation is extremely intuitive, the operability can be improved as much as possible.

Naturally, the present invention is not limited to the above mail software and music player application, and can be applied also to a browser, viewer software and the like.

For example, when a plurality of image files are displayed on a browser, the electronic device 10 may change saving order of the image files according to the tracing order, and when a plurality of links are displayed, the electronic device 10 may determine a link that is opened next according to the tracing order. Further, the link may be opened on another window according to the link tracing order.

In the electronic device of the present invention, also when the user desires to delete two or more contents collectively, the contents desired to be deleted are selected by sequential tracing. In this case, since the selection order is not required information, an order storing process is omitted.

As described above, since two or more contents can be selected by the intuitive operation, the electronic device 10 that can be easily operated sensuously can be provided to the user.

### Another Embodiment

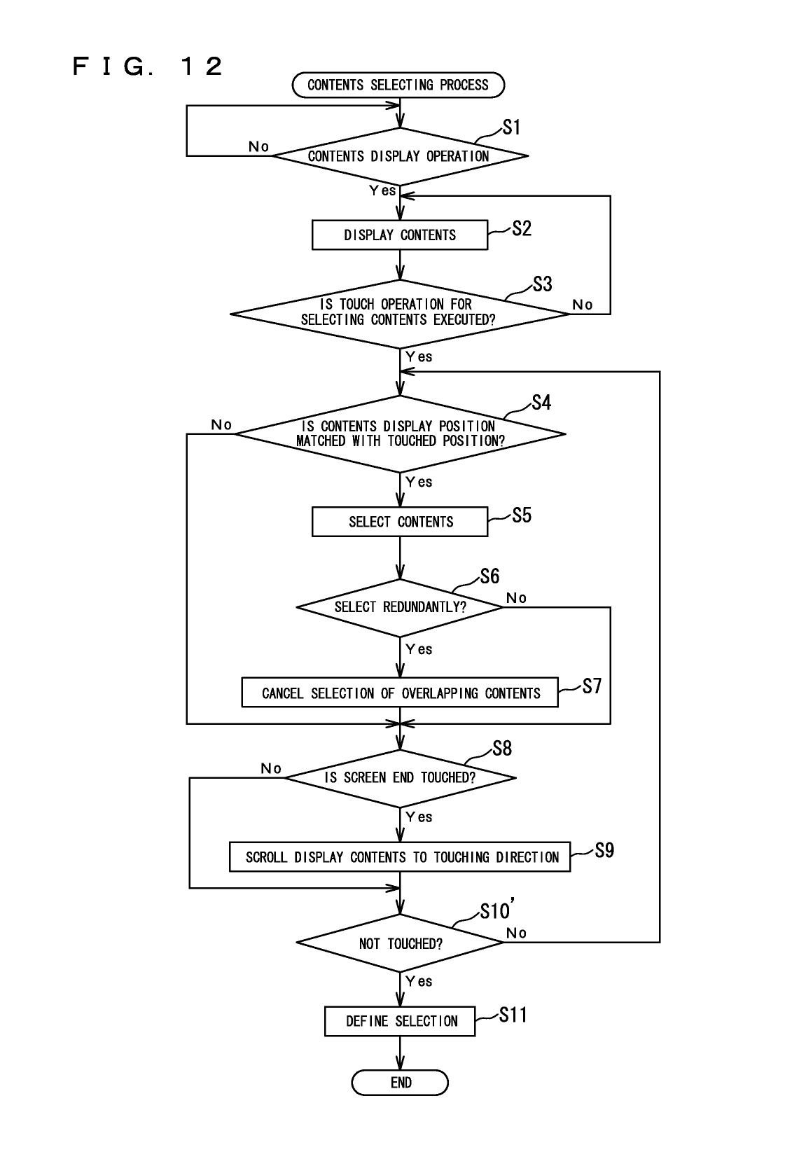

FIGS. 11 to FIG. 13 illustrate an embodiment in which the contents selecting process of the present invention varies.

In the above embodiment, when the user selects two or more contents through sliding on the touch panels 22 and 32 with the finger 100 or the like, the selecting module 72 executes the contents selecting process for sequentially selecting desired contents on the route.

In this embodiment, when the user sequentially touches the touch panels 22 and 32 with the finger 100 or the like (for example, tapping), the contents selecting process selects the contents in the input order.

Description about modules overlapping with the above embodiment is omitted, and the same symbols indicate the same members and the same steps unless otherwise noted.

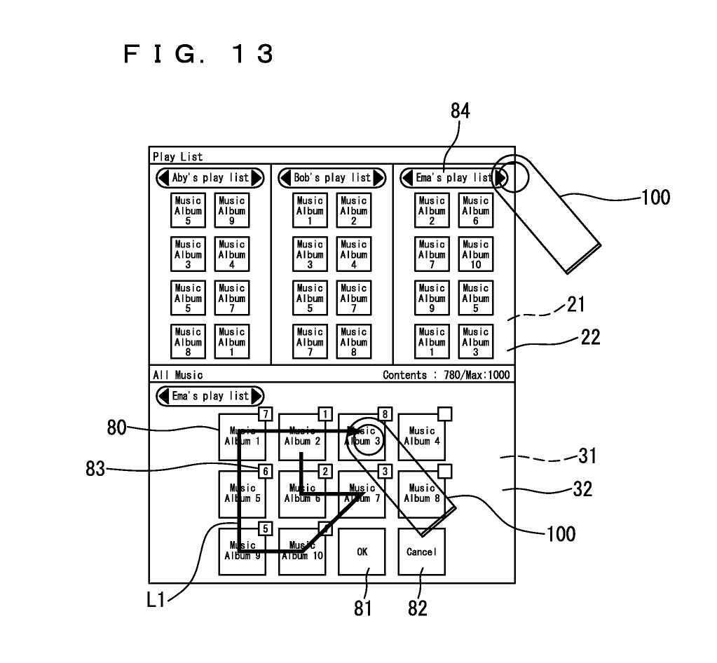

Similarly to the flowchart of FIG. 3, when the control module 60 performs the contents display operation (step 1) as shown in the flowchart diagram in FIG. 12, a plurality of contents are displayed on the first display screen 21 and/or the second display screen 31 in a list format as shown in FIG. 12 (step 2).

When the user touches the touch panels 22 and 32 with the finger 100 or the like (step 3) in a state that the contents are displayed on the display screens 21 and 31, and display positions of the contents on the display screens 21 and 31 match with the touched positions (step 4), the selecting module 72 selects and extracts the contents so as to create a list of the contents. The list is stored in the memory 61 (storage module) such as a cache memory.

More concretely, when signals are transmitted to the touch panel determining modules 25 and 35 by a user's operation on the touch panels 22 and 32 (step 3), the selecting module 72 executes a contents selecting process described below (steps 5 to 7).

The contents selecting process is, as shown in FIG. 11, a process for visually recognizing contents displayed on the display screens 21 and 31, and touching desired two or more contents on the touch panels 22 and 32 with the finger 100 or the like (for example, tapping) so as to select the contents.

When a content is present on the tapped position, the selecting module 72 selects the corresponding content (step 5).

For example, as indicated by a solid line L in FIG. 11, when the user selects the thumbnails 80 A, B, A, D, E and H (A is selected redundantly) in that order through tapping with the finger 100 or the like, the thumbnails 80 A, B, D, E and H are selected respectively.

It is desirable that the electronic device 10 blinks the selected thumbnail 80 or displays an outer frame on an outer periphery of the thumbnail 80 in order that the user easily recognizes the selection.

Further, as shown in FIG. 11, a check box 83 may be provided to an end of the thumbnail, and a check may be placed when selection is carried out. Further, it is desirable that numbers (in the drawing, 1 to 5) representing a selection order are displayed in the check boxes 83 as shown in FIG. 11 in order that the selection order is easily understood.

When contents are selected twice or more at the time of sliding, the same content is selected more than once (see the selection order in FIG. 5). Concretely, when contents are selected sequentially in the order of the solid line L in FIG. 11, the thumbnail A is selected redundantly. The overlapping thumbnail may be in the list, described later, more than once, but as shown at steps 6 and 7 in the flowchart of FIG. 12, the overlapping content selected later is deactivated as shown in the list of FIG. 5 described above in order to avoid the overlapping.

In the case where the thumbnails 80 and the icons of contents are arranged over a plurality of screens, it is desirable that when flicking on the ends of the display screens 21 and 31 or touching on the ends of the display screens 21 and 31 for a predetermined time is accepted (step 8), scrolling to the next screen is performed and the selecting operation is continued (step 9).

The above process is continued until the user completes the selection of desired contents. For example, when the contents selection at step 1 is carried out within a predetermined time (for example, for 3 seconds), the selecting operation is continued, and after the predetermined time passes, the selecting operation is regarded as being ended (step 10′), so that contents selected in the contents selecting process can be defined (step 11). As a result, the selecting module 72 creates a list of the selected contents. The user can use the created list for attachment to a mail (see FIG. 6) and creation of a library (see FIG. 13) of a playlist.

Further, after the contents selecting process by the electronic device 10 is completed, by reselecting any contents selected by the user through tapping or the like within a predetermined time, the reselected contents may be deleted from the list.

As shown in FIG. 13, thumbnails such as “OK” 81 and “Cancel” 82 are displayed on the screen, and when the user selects the thumbnail “OK” 81, the electronic device 10 may create a list. Further, when the user selects the thumbnail “Cancel” 82, the electronic device 10 may cancel the creation of the list.

As a result, since the user can select two or more contents through an intuitive operation while visually recognizing the thumbnails 80 of the contents, the operability is improved as much as possible.

FIG. 8 to FIG. 10 showing the contents selecting process and description about it can be applied also to this embodiment. In this case, the operation of tracing the touch panel may be replaced by the selecting operation by means of tapping or the like.

The electronic device 10 of the present invention can execute the above process through a program.

### INDUSTRIAL APPLICABILITY

The present invention is useful as the electronic device in which a plurality of contents can be selected through an intuitive operation and the operability is excellent.

### DESCRIPTION OF REFERENCE CHARACTERS

10 electronic device
20 first display module
21 first display screen
22 first touch panel
25 first touch-panel determination module
30 second display module
31 second display screen
32 second touch panel
35 second touch-panel determination module
40 coupling mechanism
60 control module
61 memory (storage module)
70 operating system control module
71 application control module
72 selecting module
80 thumbnail

1. An electronic device, comprising:
a display module having a display screen;
a touch panel, provided on the display screen, for accepting a touch input; and
a selecting module configured to select two or more contents about which the touch input is accepted by the touch panel when a plurality of contents are displayed on the display module, wherein
when the selected contents are reselected, the selecting module cancels the selection.

2. The electronic device according to claim 1, wherein when the plurality of contents are displayed on the display module, the selecting module can select contents displayed on a route where the touch panel accepts the touch input, and when the contents that are selected on the route where the touch panel accepts the touch input are reselected, the selecting module cancels the selection.

3. The electronic device according to claim 2, further comprising a storage module configured to store an order selected by the selecting module.

4. The electronic device according to claim 2, wherein when the selection of the contents is canceled, the selecting module deletes the contents from the order stored in the storage module.

5. The electronic device according to claim 2, wherein when the touch input is not accepted from the touch panel, the selecting module defines the selected contents as a selection target.

6. The electronic device according to claim 3, wherein when any of contents selected by the touch input on the touch panel is reselected, after the contents are defined as a selection target, the selecting module deletes the reselected content from the order stored in the storage module.

7. The electronic device according to claim 1, further comprising:
a storage module configured to store a selection order of the contents selected by the selecting module, wherein
when the selected contents are reselected, the selecting module cancels the selection, and deletes the contents whose selection is canceled from the selection order of the contents stored in the storage module.

8. The electronic device according to claim 1, wherein the contents include at least any of an image and a file name.

9. The electronic device according to claim 1, wherein at least any of an image, a file name, an icon, a thumbnail and a folder is displayed as the contents.

10. A program of an electronic device for allowing a computer of the electronic device provided with a display module having a display screen, and a touch panel, provided on the display screen, for accepting touch input, to execute
a process for selecting two or more contents about which touch input is accepted by the touch panel when a plurality of contents are displayed on the display module, and
a process for canceling the selection when the selected contents are reselected.

11. The program of an electronic device according to claim 10, wherein
the process for selecting the two or more contents is a process for selecting two or more contents displayed on a route where the touch panel accepts the touch input when the plurality of contents are displayed on the display module,
the process for canceling the selection is for canceling the selection when the contents selected on the route where the touch panel accepts the touch input are reselected.

12. The program of an electronic device according to claim 10, wherein
after the process for selecting the two or more contents, a process for storing a selection order of the selected contents is provided, and
the process for canceling the selection is a process for canceling the selection when the selected contents are reselected, and deleting the contents whose selection is canceled from the stored selection order of the contents.

13. An electronic device control method, the electronic device including
a display module having a display screen, and
a touch panel, provided on the display screen, for accepting touch input, the method comprising:
a step of selecting two or more contents about which the touch panel accepts the touch input when a plurality of contents are displayed on the display module; and
a step of canceling the selection when the selected contents are reselected.

14. The electronic device control method according to claim 13, wherein
at the step of selecting the two or more contents, when the plurality of contents are displayed on the display module, two or more contents displayed on a route where the touch panel accepts the touch input are selected, and
at the step of canceling the selection, when the contents selected on the route where the touch panel accepts the touch input are reselected, the selection is canceled.

15. The electronic device control method according to claim 13, wherein
after the step of selecting the two or more contents, a step of storing a selection order of the selected contents is provided,
at the step of canceling the selection, when the selected contents are reselected, the selection is canceled, and the contents whose selection is canceled are deleted from the selection order of the contents stored in the storage module.
